(19) United States
(12) Patent Application Publication
(10) Pub. No.: US 2008/0245807 A1
(43) Pub. Date: Oct. 9, 2008

(54) Closure For Refuse Container

(76) Inventor: Peter William Harkins, New South Wales (AU)

Correspondence Address: KING & SCHICKLI, PLLC, 247 NORTH BROADWAY, LEXINGTON, KY, 40507, US

(21) Appl. No.: 10/573,192

(22) PCT Filed: Oct. 6, 2004
(86) PCT No.: PCT/AU2004/001360

§ 371 Date: Jun. 24, 2008

(30) Foreign Application Priority Data
Oct. 7, 2003 (AU) 2003905472

(51) Int. Cl. B65F 1/16; B65D 51/04

(52) U.S. Cl. 220/848

(57) ABSTRACT

A hinged closure for a refuse container, the closure including a main panel portion (12) having opposed side edges (13,14) with dovetail like ribs or tongues (41), and the closure further including two side members (20, 30) each of which have grooves (42) adapted to be associated with a respective side edges of the main panel portion for a releasable connection. The main panel portion is connected to the side members by sliding the ribs in the grooves until pivot mounting hole portions of the both the panel portion and side members are aligned to form a pin mounting sleeve (45). The side members provide increased rigidity and reinforcement to the pivotally mounted closure.

This invention relates generally to containers or receptacles suitable for handling refuse and more particularly, to a closure suitable for use with such a container.

Refuse containers or bins which are used usually for handling refuse materials in commercial situations generally comprise a metal container or bin having an open top for receiving the refuse material therein. The open top has a closure or lid thereon which is usually pivotally mounted. The containers or bins are arranged so that they can be picked up by a machine and tipped for emptying into a refuse collecting vehicle or the like.

The containers or bins are usually made from metal and the lids are often formed from plastics material. Such refuse containers suffer from the problem that because of the rough manner in which they are handled, the lids tend to be damaged and need to be relatively frequently replaced.

It is an object of the present invention to provide an improved closure for a refuse container which alleviates the aforementioned problem.

According to the present invention there is provided a closure for a refuse container, the closure including a main panel portion having opposed side edges, the closure further including side members, each of which is adapted to be associated with a respective side edge of the main panel portion, the side members being of greater rigidity than the main panel portion, cooperating connector parts associated with the main panel portion and side members for releasably connecting each of the side members to a respective side edge of the main panel portion, and a pivot mounting for pivotally mounting the closure to the refuse container.

In one preferred form, the main panel portion is a generally flat member which is generally square or rectangular in plan having opposed end ends extending between the opposed sides, the pivot mounting including a pivot mounting section at one of the ends. Preferably each side member of the closure is in the form of an elongated bar shaped element having sides which are about the same length of the sides of the main panel portion, each side member including opposed ends, and said pivot mounting including a further pivot mounting section at one end thereof.

The connector parts may include a tongue and cooperating groove, the tongue being formed on one of either the main panel portion or one of the side members and the groove being formed on the other of the main panel portion or one of the side members. Preferably two tongues are provided one extending along each of the sides of the main panel portion and each side member includes two grooves each formed in a respective side there, the main panel portion and side member being connectable together by sliding the tongue into the groove at one end thereof. The pivot mounting is in the form of a pin receiving sleeve operatively mounted to the main panel portion and/or the side members.

A metal reinforcement may be embedded within the side members in the region of the pivot mounting sections and extending along the side members towards the other end and/or main panel portion.

The pivot mounting may be provided at one of the ends and a handle may be provided at the other of the ends. The main panel portion may be of a hollow box section configuration.

Each side member may include ends, one end of which has a pivot mounting thereon and the other end may include a handle portion. Preferably, the side members are dimensioned or configured so that they form a stronger and more rigid structure than the main panel portion.

The closure assembly may further include a metal reinforcement embedded in the side member in the region of the pivot mounting sections and embedded in the side members in the region of the pivot mounting sections and embedded within in the side members and/or main panel portions. In one form the metal reinforcement is associated with the side members and includes spaced apart side bars with a sleeve extended between the side bars at one end thereof the sleeve defining the pin mounting sleeve and a cross rod extending between the side bars at the other end thereof.

As will be appreciated because in a preferred embodiment each of the side members includes two grooves one on either side thereof, the side members can be orientated relative to the panel member in four different configurations; that is, one side member can be connected to one side of the main panel portion in two different orientations and further the side members can be swapped so that they can be connected to the opposite side of the main panel portion.

The pivot mounting may be in the form of a pin receiving sleeve operatively mounted to the main panel portion and/or the side members.

Preferably, the closure is formed from metal or plastics material and may be manufactured using any suitable manufacturing technique such as, rotational moulding.

Preferred embodiments of the invention will hereinafter be described with reference to the accompanying drawings, and in those drawings:

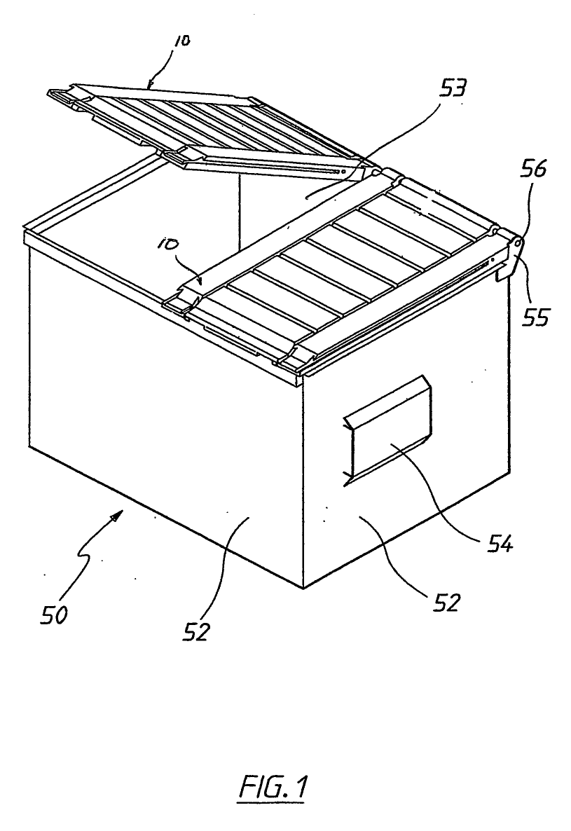

FIG. 1 is a schematic perspective view of a typical refuse container with which the closure of the present invention is suitable for use;

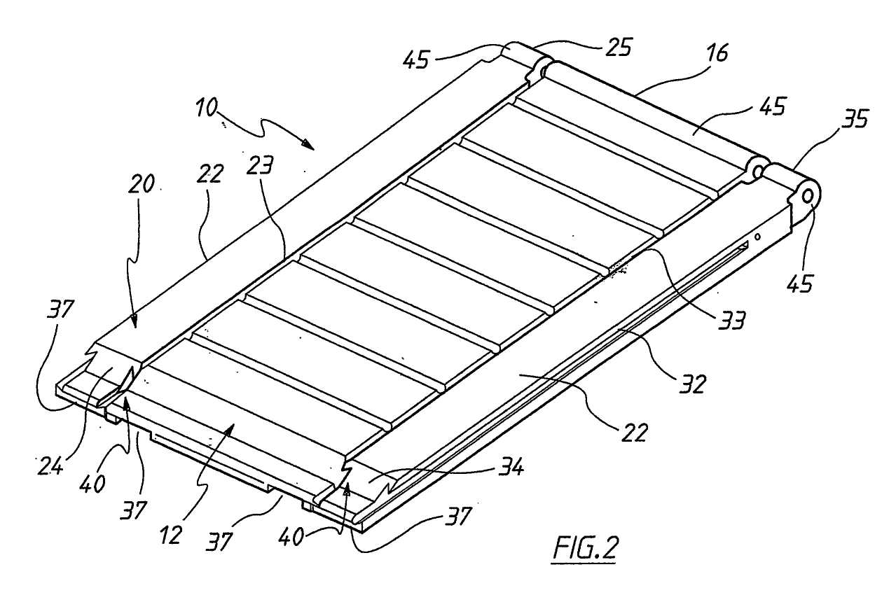

FIG. 2 is a schematic illustration of an example of a closure according to the present invention;

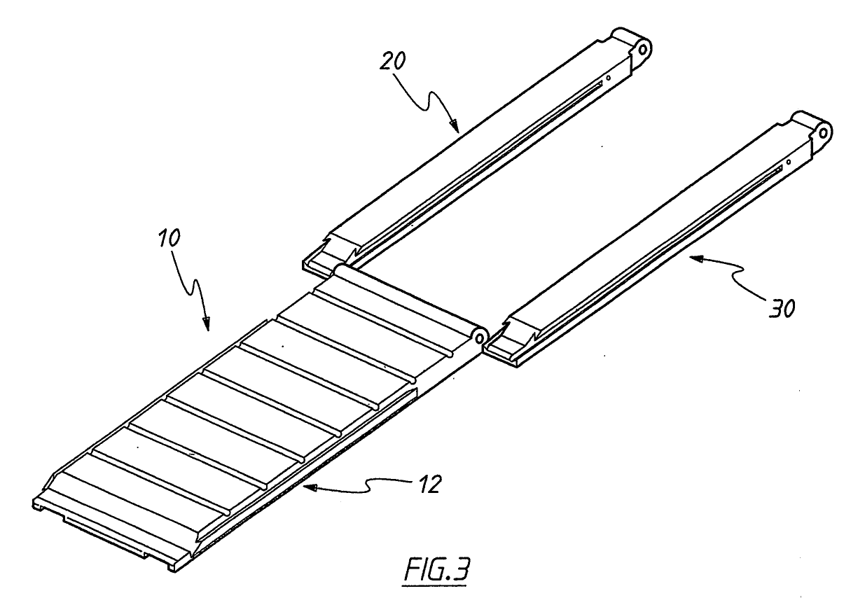

FIG. 3 is a further illustration of the closure shown in FIG. 2 with the main panel portion and side members partially separated from one another;

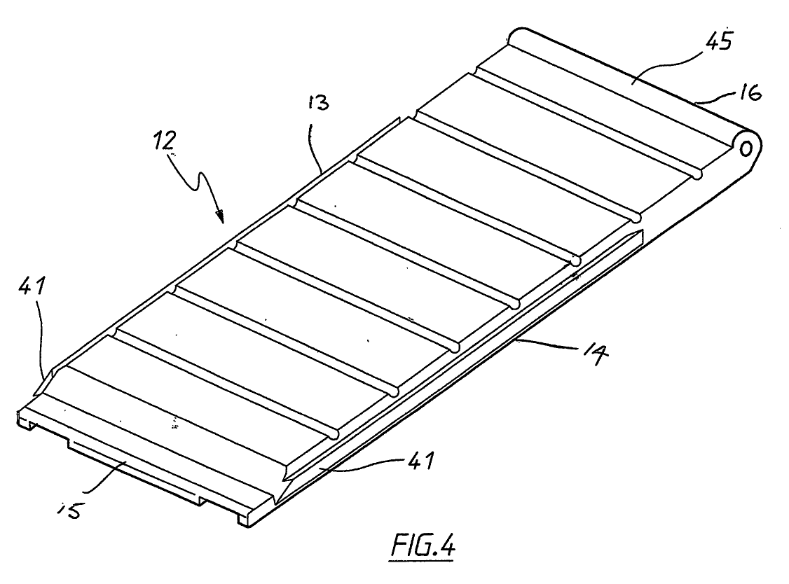

FIG. 4 is a schematic isometric view of a main panel of a closure according to the present invention;

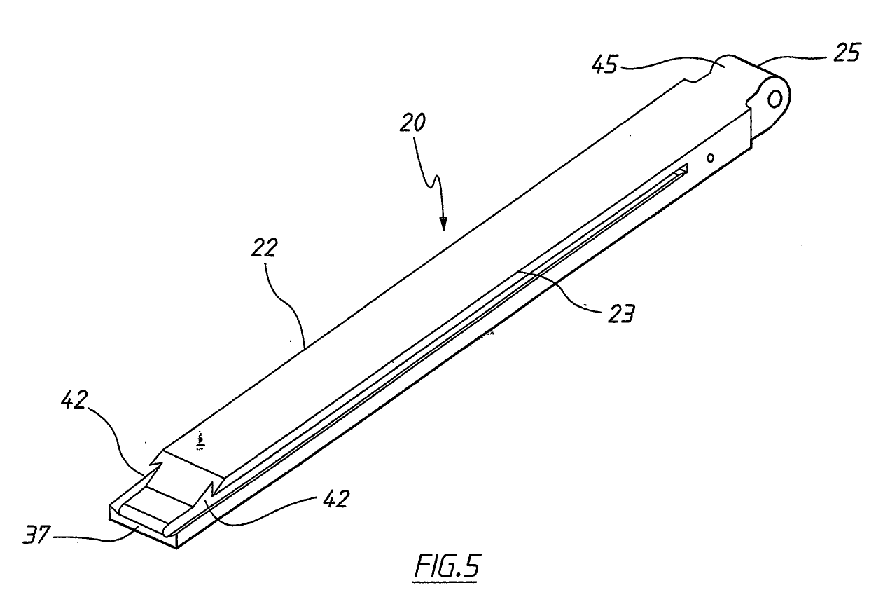

FIG. 5 is a schematic isometric view of a side member forming part of the closure of the present invention, and

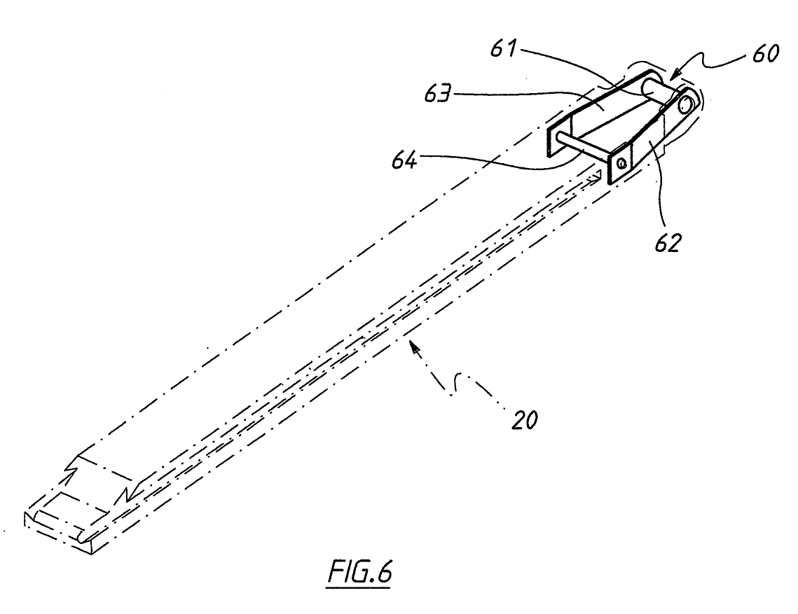

FIG. 6 is an isometric view of a side member wherein the reinforcing is illustrated.

Referring to the drawings there is shown in FIG. 1 a refuse bin generally indicated at 50 which comprises a box shaped body 52 having an open top 53. Lifting channels 54 are provided on each side of the body of the refuse bin enabling the bin to be lifted by means of a fork lift machine. A hinge pin mount 55 is provided at the rear of the bin for receiving a hinge pin 56. The refuse bin is formed of steel or other suitable metal. Two closures 10 are pivotally mounted at the top of the bin.

As best shown in FIGS. 2 and 3, a closure 10 according to a preferred form of the invention includes a main panel portion 12 and two side members 20 and 30. The main panel portion 12 is generally square or rectangular when viewed in plan and has opposed sides 13 and 14 and opposed ends 15 and 16. The panel 12 includes a pivot mounting 45 at end 16 in the form of a pin receiving sleeve. The panel 12 is in the form of a box section structure formed of plastics material which is preferably rotationally moulded.

The closure further includes side members 20 and 30 each being in the form of an elongated element 21 and 31 having sides 22, 23, and 32 and 33 and ends 24, 25 and 34 and 35. The side members are dimensioned so as to provide a more rigid and stronger structure than the main panel portion 12. In the embodiment is shown handle sections 37 provided at one end of the main panel portion and side members. A pivot mounting 45 in the form of a pin mounting sleeve is provided at one end of each and side member and each have a generally box section structure and are formed of plastics material which is preferably rotationally moulded.

As shown in FIG. 5, a metal reinforcement 60 is provided in each of the side members. The reinforcement is embedded within the side members during the manufacturing process. The reinforcement includes side bars 62 and 63 with sleeve at one end thereof and a cross rod pin mounting sleeve 61 connected to and extending between the bars at an end and a cross rod 64 connected to an extending between the bars at the other end. In another arrangement, a single piece steel insert may be embedded within the side member and extend from the pivot mounting towards the other end.

The main panel portion 12 and each of the side members 20 and 30 have cooperating connector parts 40 enabling releasable connection of the side members to the main panel portion. As shown, the coupling parts includes a dovetail like rib or tongue 41 on each of the side members which is adapted to cooperate with complementary shaped grooves 42 on the main panel. As shown, each side member has a dovetail rib 41 on both sides thereof. As shown in FIG. 3, connection of the parts can be effected by relative axial movement therebetween.

The closure of the present invention provides significant advantages over the prior art. By far the most commonly damaged section of currently known closures is in the outer side and pivot portion at the outer edge of each closure. By providing a narrow more rigid side section along each side of the main panel portion they can more readily lend themselves to the use of a single piece steel insert connecting the stay pivot and the main hinge. The structural box section at the supporting side of the container will increase strength in the area where its most required and the insert will extend at least partially along the length of each side section. The arrangement allows each closure to be used in a number of alternative positions on the container. Should the pivot and/or hinge be damaged in its initially installed position it can be rearranged in three alternative ways. Furthermore, the closure can be lighter whilst retaining the same strength reducing loads on the closure and any hazard to operators. Each of the parts of the closure can be readily replaced if they become damaged.

Finally, it is to be understood that various alterations, modifications and/or additions may be incorporated into the various constructions and arrangements of parts without departing from the spirit or ambit of the invention.

1. A closure for a refuse container, the closure including a main panel portion having opposed side edges, the closure further including side members, each of which is adapted to be associated with a respective side edge of the main panel portion, the side members being of greater rigidity than the main panel portion, cooperating connector parts associated with the main panel portion and side members for releasably connecting each of the side members to a respective side edge of the main panel portion, and a pivot mounting for pivotally mounting the closure to the refuse container.

2. A closure assembly according to claim 1 wherein the main panel portion is a generally flat member which is generally square or rectangular in plan having opposed end ends extending between the opposed sides, the pivot mounting including a pivot mounting section at one of the ends.

3. A closure assembly according to claim 2 wherein each side member of the closure is in the form of an elongated bar shaped element having sides which are about the same length of the sides of the main panel portion, each side member including opposed ends, and said pivot mounting including a further pivot mounting section at one end thereof.

4. A closure assembly according to claim 3 wherein the connector parts include a tongue and cooperating groove, the tongue being formed on one of either the main panel portion or one of the side members and the groove being formed on the other of the main panel portion or one of the side members.

5. A closure assembly according to claim 4, wherein two tongues are provided one extending along each of the sides of the main panel portion and each side member includes two grooves each formed in a respective side there, the main panel portion and side member being connectable together by sliding the tongue into the groove at one end thereof.

6. A closure assembly according to claim 5 wherein the pivot mounting is in the form of a pin receiving sleeve operatively mounted to the main panel portion and/or the side members.

7. A closure assembly according to claim 6 further including a metal reinforcement embedded in the side members in the region of the pivot mounting sections and embedded within in the side members and/or main panel portion.

8. A closure assembly according to claim 7 wherein the metal reinforcement is associated with the side members and includes spaced apart side bars with a sleeve extending between the side bars at one end thereof the sleeve defining the pin mounting sleeve and a cross rod extending between the side bars at the other end thereof.
